(19) United States
(12) Patent Application Publication
(10) Pub. No.: US 2022/0000309 A1
(43) Pub. Date: Jan. 6, 2022

(54) User-Programmable Automated Cooking Apparatus

(71) Applicant: Kitchen Robotics Ltd, Modiin (IL)

(72) Inventors: Ofer ZINGER, Rehovot (IL); Yair GORDIN, Modiin (IL)

(21) Appl. No.: 16/920,788

(22) Filed: Jul. 6, 2020

(51) Int. Cl. A47J 36/32; A47J 44/00; A47J 27/14

(52) U.S. Cl. CPC A47J 36/321; A47J 27/14; A47J 44/00

(57) ABSTRACT

The present invention is an automated cooking apparatus and its method of operation, also referred to as robotic chef, that is flexible and that a chef may program, which allows addition of a new recipe by the end users (e.g., the chef in charge of a specific restaurant or menu), modification of a recipe, or the like. Additionally or alternatively, the new recipe may be obtained from a repository of recipes such as retained in a database, in a cloud storage, or the like.

### FIELD OF THE INVENTION

The present invention relates to an automated cooking apparatus with programmable features. Moreover, said invention allows addition or programming of a new recipe by the end users (e.g., the chef in charge of a specific restaurant or menu), its modification or manual editing by the end users or selecting from a repository of recipes retained in a database, cloud storage, or the like.

### BACKGROUND OF THE INVENTION

Cooking for human consumption entails use of heat at different temperatures for boiling, frying, baking and the like. Various cooking techniques are in vogue all over the world in line with the numerous cultural and various other socio-economic traditions involving different ways of prepping the ingredients, spicing the ingredients, and dispensing the ingredients into a cooking apparatus in a specific order.

In accomplishing the above cooking techniques, various implements have been developing since antiquity. As a result, specific cooking implements for baking, roasting, frying, grilling, barbecuing, smoking, boiling, steaming and braising, etc. have been developed and used widely. With the advent of advanced technologies, the cooking implements are going hi-tech. Various automated cooking apparatus have been/are being developed to undertake above stated cooking options in a selective manner.

In US20080110347A1 titled, “Automated cooking apparatus”, an automated cooking apparatus to replicate a chefs stir-frying cooking skills on using a utensil, a combination of using a utensil and wok-flip mechanism, or a wok-flip mechanism to enhance cooking results is discussed.

US20140331869A1 titled, “Automated cooking apparatus having air flow regulation and reduced fire hazard” talks of an automated cooking apparatus including a computer system configured to store a recipe and a cooking apparatus that includes: a frying pan that can hold food ingredients, a heater that can heat the frying pan under the control of the computer system based on the recipe, an exterior body that can hold the frying pan and the heater, and a lid that can keep food ingredients in the frying pan while the food ingredients are stirred and mixed during cooking. A lid-movement mechanism can open and close the lid under the control of the computer system. A transport mechanism can move the frying pan and the cooking apparatus, under the control of the computer system, to mix, stir, or distribute the food ingredients in the frying pan to produce a cooked food.

U.S. Pat. No. 5,791,234A titled, “Two-sided cooking apparatus having an electronic gap adjustment mechanism” discusses a clamshell or two-sided cooking system that utilizes an upper platen and a lower platen. The upper platen is movable to a non cook and to a cook position. In the cook position, the upper platen is separated from the lower platen by a gap.

The gap can be electronically adjusted for various thicknesses of foodstuffs. Preferably, an electronic adjustment mechanism is located within the upper platen assembly. The adjustment mechanism utilizes a drive means which inherently provides float to accommodate variations in thicknesses of the foodstuffs.

U.S. Pat. No. 5,881,632A titled, “Automatic cooking apparatus” discusses a computerized cooker which sequentially enters numerous food items into various cooking pots and introduces liquid ingredients as well. Food is cooked in accordance with a specified computer program.

However, in none of these inventions, use of pre-assigned cooking process through incorporation of requisite command is seen. As a result, inflexibility in the execution of a complex recipe without manual intervention becomes pertinent. The present invention focuses in removing manual intervention through a process of pre-assigned programming of different cooking steps to enable accomplish different recipes in a mechanized manner.

### SUMMARY OF THE INVENTION

In one aspect of the present invention, an automated cooking apparatus, also referred to as robotic chef, is provided that is flexible and that a chef may program, which allows addition of a new recipe by the end users (e.g., the chef in charge of a specific restaurant or menu), modification of a recipe, or the like. Additionally or alternatively, the new recipe may be obtained from a repository of recipes such as retained in a database, in a cloud storage, or the like.

In another aspect of the present invention, efficiency of a recipe may be measured by resource utilization, preparation time, energetic consumption, ingredients costs, nutrition, combination thereof, or the like.

In another aspect of the present invention, the cooking apparatus is provided with a database, in a cloud server storage, which may comprise information about the nutritional value of different ingredients, allergens existing in each ingredient, or the like. It may comprise information about the change of nutritional value depending on the cooking techniques. Further, it may also comprise information regarding the cost of each ingredient. Additionally or alternatively, the database may comprise information regarding the cost of energy units utilized during cooking (e.g., kWh, cost of cooking gas, or the like).

A still further aspect of the present invention is to utilize the database in calculating the cost of the dish, the nutritional value of the dish, or the like.

A further aspect of the invention is to suggest different variations of a dish automatically, such as by proposing modifications to optimize the dish, depending on a desired target function.

In another aspect of the present invention an effort is to provide an user interface to the user, for planning the dish, for controlling inputting of the ingredients (amount, order, timing, or the like), for controlling the dish preparation (technique, level of cooking, mixing speed, temperature level, or the like).

In a still further aspect of the present invention, the robotic device may attempt to create variations of the dish to reduce cost, or to provide some potential improvement.

In a still further aspect of the present invention, provision of a robotic chef which automatically performs a modification to a recipe by taking into account user preferences, allergies, or the like.

A further aspect of the invention is to provide a robotic chef which may be mobile, transferrable, or the like. It may be installed in a food truck or may be transported to different locations at different times and deployed in different venues.

An important aspect of the invention is to provide a robotic chef which controls the overall dish preparation operation which may include not only, the inputting the amount of ingredients, the order and timing of the dish but also the technique involved in cooking including level of cooking, mixing speed and temperature level to be maintained during cooking operation. It may also include suggestions to improve the dish.

In an aspect of the invention once a new recipe is finalized and a desired programming defined for the recipe, the same is transferred over a network to a plurality of robotic chefs so as to allow them to implement the new recipe. Thus, for a menu that is needed to be altered by the head chef of a restaurant chain, the same can be updated by him and the menu of the entire chain of restaurants altered accordingly by a single managing person.

In still another aspect of the invention, a future prediction of the usage, the type, the quantity of ingredients, and the techniques to be used for preparing a variation of the recipe may be based on previously stored data in the database of the cloud server. Such application of historical data provides accurate information and advantage in cooking novel recipes, thereby giving the robotic chef an edge over the existing art.

In still another aspect of the invention, a predictive model may be used to generate titles or descriptions for dishes based on the popularity of the dishes determined by the percentage of purchases from all customers; number of overall purchases and number or percentage of returns of the dish.

In still another aspect of the invention, the robotic chef may be provided with a “regular mode” which allows the recipe to be prepared without monitoring and videotaping and a “chef/debug mode”, in which the recipe is monitored, recorded and variations on the recipe performed automatically, but with the provision that, the user is presented with the variations, for viewing.

In still another aspect of the invention, the robotic chef may be connected to a cloud server which may manage a database of recipes, track inventory and manage supply. It may also monitor actual orders, customer profiles, customer reaction to dishes, and may further be utilized to determine the pricing dynamically and also to communicate the takeaway prices.

In still another aspect of the invention, artificial neural networks and deep learning may be employed to provide suggestions to reduce the likelihood a dish is returned, increase perceived popularity of the dish and change the price of the dish.

In a further aspect of the invention, the cloud server may additionally function as a monitoring station and keep track of the orders received and the supplied number of orders with respect to the recipes based on the user demand as well as provides a visual dashboard that may visualise the order flow and the appropriate supply chain. It may also function in tracking the usage of alternative ingredients in the recipe towards modifying it, based on available ingredients and determining the use of best alternative for an ingredient.

In a still further aspect of the invention, the cooking time of each dish may be shown visually, enabling the user to perceive the order of dish preparation, and anticipated dish completion time. In this aspect, different color schemes may be utilized to indicate different statuses of dishes, different preparation stages, alerts, apart from the expected time until the dish is served. Additionally/optionally, another aspect of the present invention allows the freedom of providing the user a smart interface whereby, translation of text to voice messages/alerts and vice-versa is enabled, thereby, negating the use of the screens and raising the productive time of the employees/users.

In another aspect of the invention, the apparatus may have raw material visualization, wherein the status of each feeder and amount of ingredients may be shown. It may also include inventory of each ingredient as well. For enhancing the visibility and understanding, and for directing the user's attention, different colors may be used, for important tasks, such as ensuring additional stock is ordered to replenish inventory or filling a feeder. To enhance the potential, an expected time until a feeder is depleted may be indicated. The inventory may be tracked by tracking the amount of incoming stock and use thereof via the feeders.

### BRIEF DESCRIPTION OF THE DRAWINGS

FIG. 1 is a flowchart representing a method of implementation in accordance with some exemplary embodiments of the disclosed subject matter.

FIG. 2 is a flowchart representing a method of analyzing and implementing variations in the recipe with respect to the recipe provided by the user.

FIG. 3 is a visual representation of a dish status, in accordance with some exemplary embodiments of the disclosed subject matter.

FIG. 4 is visual representation of raw materials in the cooking apparatus, in accordance with some exemplary embodiments of the disclosed subject matter.

### DETAILED DESCRIPTION OF THE PREFERRED EMBODIMENTS

One technical problem dealt with by the disclosed subject matter is to provide an automated cooking apparatus, also referred to as robotic chef, that is flexible and that a chef may program without any specific programming knowledge. It may be desired to allow addition of a new recipe by the end users (e.g., the chef in charge of a specific restaurant or menu), modification of a recipe, or the like. In some cases, the new recipe may be defined manually by the end users. Additionally or alternatively, the new recipe may be obtained from a repository of recipes such as retained in a database, in cloud storage, or the like.

In some exemplary embodiments, it may be desired to use a same robotic chef in different restaurants, using the same equipment, to create new recipes, improved recipes, more efficient recipes, or the like. Efficiency of a recipe may be measured by resource utilization, preparation time, energetic consumption, ingredients costs, nutrition, combination thereof, or the like.

One technical solution is to provide a robotic chef with a plurality of replaceable feeders. Ingredients may be replaced by replacing the feeders or by re-stocking a feeder. Using feeders' IDs, such as RFID, barcode, or the like, the robotic chef may be informed of the available ingredients and feeders and may be able to select an ingredient for dispensing. The ingredients may be dispensed into a cookware. The cookware may be utilized for cooking the ingredients, using different cooking techniques, such as but not limited to boiling, mixing, grilling, sautéing, leavening, or the like. One or more sensors may be may be mounted in the cookware, monitoring the ingredients and the preparation process. The sensors may include, for example, a camera that is capable of capturing the appearance of the ingredients/dish during the cooking process. Additionally or alternatively, the sensors may include a temperature sensor for measuring temperature in a location within the cookware, a weight-scale, volume sensor, or the like. In some exemplary embodiments, the sensor may be placed in a location that is isolated to not be overheated. The sensor may communicate, such as wirelessly, with a monitoring station. The monitoring station may be a part of the robotic chef, a separate apparatus, or the like.

The user, such as a human chef, may monitor the cooking process via the monitoring station. There may be a screen showing the video or images from the video captured by the camera. The screen may also show additional information such as amount of each ingredient, the types of ingredients used, cooking phases, a time duration of each cooking phase, images at key frames, such as the beginning and end of each cooking phase, or the like.

In some cases, the user may plan the cooking process. After the initial plan is fed into the robotic chef, the plan may be executed, and monitored. The user may monitor the process while it is being performed or viewed later after it has been concluded.

In some exemplary embodiments, a database may comprise information such as useful for estimating effects on the nutritional value of the ingredients. In some exemplary embodiments, the database may comprise nutritional value of different ingredients, allergens existing in each ingredient, or the like. The database may comprise information about the change of nutritional value depending on the cooking techniques. For example, the nutritional value of rice may change based on the manner of cooking. Different changes may occur for boiling, steaming, frying, or the like. Additionally or alternatively, minerals and vitamins may be damaged during the cooking process, such as when the temperature rises over a threshold. Additionally or alternatively, the database may comprise information regarding the cost of each ingredient. Additionally or alternatively, the database may comprise information regarding the cost of energy units utilized during cooking (e.g., kWh, cost of cooking gas, or the like).

In some exemplary embodiments, the database may be utilized to calculate the cost of the dish, the nutritional value of the dish, or the like. Different variations may be suggested automatically, such as by proposing modifications to optimize the dish, depending on a desired target function. Replacing butter with margarine may be suggested as a means to reduce the cost of the dish. As another example, replacing palm oil with olive oil may be useful to improve nutritional value of the dish.

In some exemplary embodiments, the user may utilize the user interface to plan the dish, to control inputting of the ingredients (amount, order, timing, or the like), to control the dish preparation (technique, level of cooking, mixing speed, temperature level, or the like). The device may provide suggestions to improve the dish.

In some exemplary embodiments, the robotic device may attempt to create variations of the dish. Each variation may be modified to reduce cost, or to provide some potential improvement. The variation may be attempted and the user may be provided with several variations to select the optimal plan. For example, the cooking time may be reduced by 10 seconds, 20 seconds, 30 seconds, and the user may decide if he wishes to adopt such suggestion based on the outcome and the monetary savings. In some cases, reducing the cooking time may provide benefits from the operational aspect, so as to allow an increase in output of the robotic chef in particular and of the restaurant in general. As another example, different variations to the amount of salt added to the dish may be provided, and the user may select the salt amount based on the preferred outcome.

In some exemplary embodiments, after a desired programming is defined and selected, the recipe may be transferred over a network to a plurality of robotic chefs so as to allow them to implement the new recipe. As another example, a cloud-based server may be utilized and be queried to obtain the up-to-date recipe.

In some exemplary embodiments, the robotic chef may be mobile, transferrable, or the like. The robotic chef may be installed in a food truck. Additionally or alternatively, the robotic chef may be transported to different locations at different times and deployed in different venues.

In some exemplary embodiments, an entire chain of restaurants may be updated to change its menu by a single command of the person in charge of the menu of the chain. In some exemplary embodiments, based on the recipe, such as based on the cooking technique, the ingredients, or the like, a title for the dish may be suggested automatically. The description of the dish may be suggested automatically as well. In some cases, manual title and/or description may be provided and a software may determine whether or not it is accurate. In some cases, the generation of the title/description may be based on similar dishes and their popularity, such as using Artificial Neural Networks and using popular dishes and their respective popularity (e.g., percentage of purchases from all customers; number of purchases overall; number or percentage of returns of the dish; or the like), a predictive model may be used to generate titles/descriptions that are estimated to be popular for a given recipe.

In some exemplary embodiments, the robotic chef may have a regular mode in which the recipe is prepared without being monitored and videotaped. Another mode may be “chef 5 mode” or “debug mode” in which all data may be monitored, recorded and provided for the user to see. In some cases, during chef mode, variations may be suggested and performed automatically.

In some exemplary embodiments, the robotic chef may track statistics about each dish, such as but not limited to the number of times the dish is order, the percentage of customers who purchased the dish, the number of times the dish was returned, the percentage of times the dish was returned, the volume of waste left after the dish is consumed by the customer, or the like. Such statistics may be utilized to provide automated suggestions to modify a dish or its description. For example, using deep learning, an Artificial Neural Network may be utilized to provide suggestions to reduce the likelihood a dish is returned, increase perceived popularity of the dish, change the price of the dish, or the like.

Additionally or alternatively, the robotic chef may provide an automated warning regarding allergens. In some cases, the customer may provide his medical information in a digital manner, or such information may be available to the robotic chef. The allergens and the medical condition of the customer may be compared to determine a potential risk.

Additionally or alternatively, the robotic chef may automatically perform a modification to a recipe to take into account user preferences, allergies, or the like. For example, a customer may indicate she would like to receive a dish without carrot, due to her personal preference or due to a medical condition. The robotic chef may implement such modification. In some cases, the robotic chef may indicate that a certain modification cannot be performed, based on user provided information (e.g., the human chef may define an ingredient as a mandatory ingredient), based on automatically deduced information (e.g., perceived likelihood of returning a dish when an ingredient is not used), or the like.

In some exemplary embodiments, the robotic chef may modify a recipe based on existing ingredients. Supplements may be utilized instead of originally defined ingredients. The robotic chef may track the use of supplements and determine which supplement performs well and which performs badly and should not be used. For example, the robotic chef may determine that apple in one dish may be replaced by a pear, but not with a peach. As another example, in a different dish it may be determined that a peach is a suitable supplement to an apple, but a pear may be unsuitable.

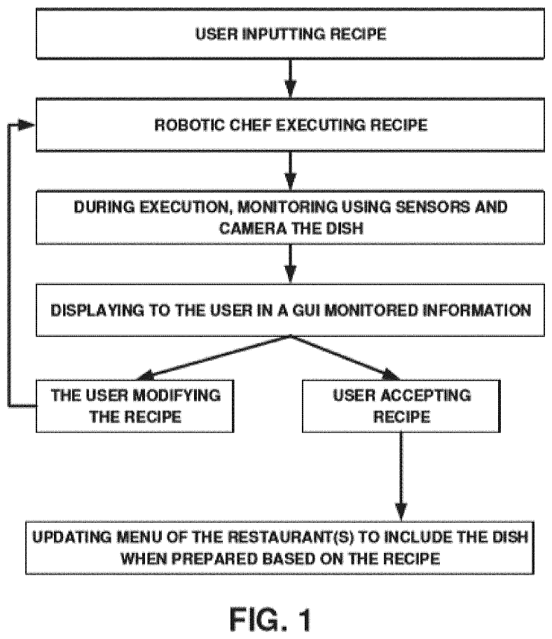

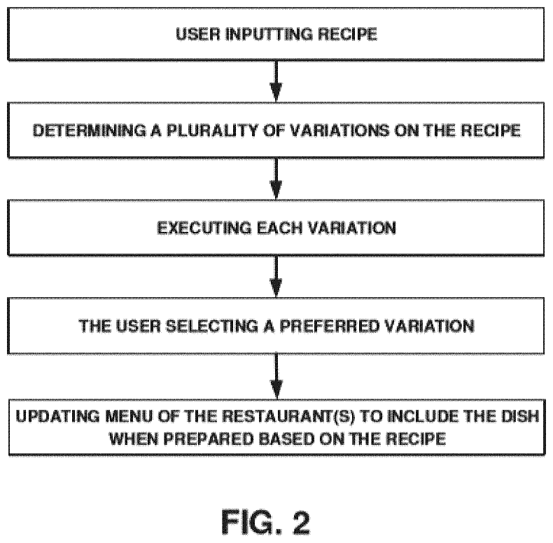

In some exemplary embodiments, the disclosed subject matter may be implemented using methods such as depicted in FIGS. 1 and 2.

FIG. 1 exemplifies a method of implementation in accordance with some exemplary embodiments of the disclosed subject matter. In this method, the robotic chef implements the dish in the following steps:

Step 1 (S1): sending instructions by the user via the GUI to the cooking apparatus for a recipe to be cooked.

Step 2 (S2): receiving cooking instructions by the cooking apparatus from the user, about the recipe to be cooked.

Step 3 (S3): executing the recipe by the cooking apparatus, aided by the monitoring station which receives various information from the sensors about the status of the recipe, including visual interpretation.

Step 4 (S4): displaying to the user real-time cooking status of the recipe through the GUI.

Step 5 (S5): prompting the user, to either modify the recipe or accept the recipe.

Step 6 (S6): Updating the menu of the restaurant, if the user accepts the recipe.

If the user modifies the recipe, repeating the steps from Step S2.

FIG. 2 exemplifies a method of analyzing and implementing variations in the recipe with respect to the recipe provided by the user in the following steps:

Step 1 (S1): sending instructions by the user via the GUI to the cooking apparatus for a recipe to be cooked.

Step 2 (S2): receiving cooking instructions by the cooking apparatus from the user, about the recipe to be cooked, which sends information to the monitoring station, to analyze the repository of recipes in the database, of the cloud server and selecting a plurality of variations of the recipe.

Step 3 (S3): executing each of the variations of the recipe by the cooking apparatus and presenting them to the user for their selection;

Step 4 (S4): selection of a preferred variation of the recipe by the user.

Step 5 (S5): Updating the menu of the restaurant, with the selected variation of the recipe.

In some exemplary embodiments, the robotic chef may be connected to a cloud server. The cloud server may manage a database of recipes, may track inventory and manage supply. The cloud server may monitor actual orders, customer profiles, customer reaction to dishes, or the like. In some exemplary embodiments, the cloud server may be utilized to determine the pricing dynamically. Additionally or alternatively, the cloud server may communicate with takeaway services. Additionally or alternatively, the cloud server may be in charge for dish personalization on behalf of the robotic chef. Additionally or alternatively, the cloud server may provide a visualization dashboard and may function as the monitoring station. The visualization dashboard may visualize the order flow and supply chain. In some exemplary embodiments, optimization may be performed by the cloud server so as to reduce the leftovers and returns, optimize dish cost, determine alternative ingredients, or the like. In some exemplary embodiments, the cloud server may implement menu and ordering services enabling the end-customer to perform her order directly.

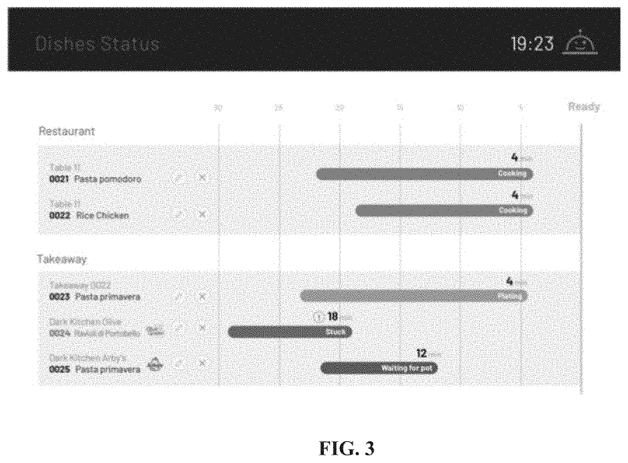

FIG. 3 exemplifies a dish status visualization, in accordance with some exemplary embodiments of the disclosed subject matter. Cooking time of each dish is shown in a visual manner, enabling a human to perceive the order of dish preparation, and anticipated dish completion time. As is illustrated in this figure, different color schemes may be utilized to indicate different statuses of dishes, different preparation stages, alerts, or the like. The expected time until the dish is served may be shown.

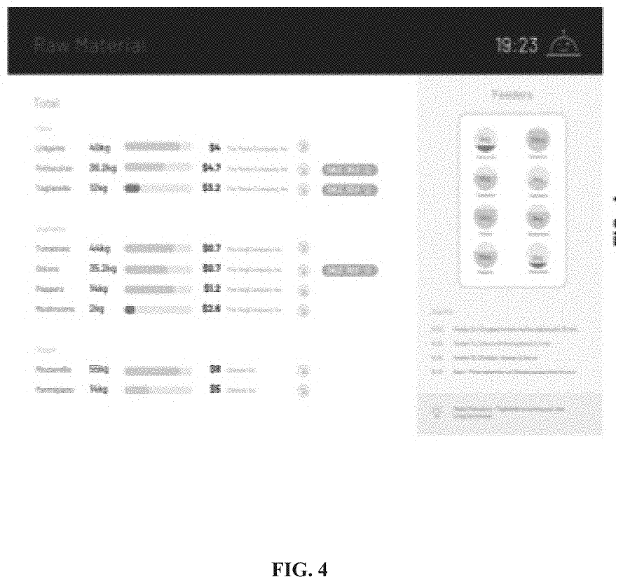

FIG. 4 exemplifies a raw material visualization, in accordance with some exemplary embodiments of the disclosed subject matter. The status of each feeder and amount of ingredients may be shown. Inventory of each ingredient may be shown as well. Different colors may require different attention of the user, such as ensuring additional stock is ordered to replenish inventory or filling a feeder. In some exemplary embodiments, an expected time until a feeder is depleted may be indicated. The inventory may be tracked by tracking amount of incoming stock and use thereof via the feeders.

Additionally or alternatively, inventory prices may be monitored and sale events or opportunities may be presented to the owner of the restaurant.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the 15 like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can 10 direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be appreciated by persons skilled in the art that the present invention is not limited by what has been particularly shown and described hereinabove. Rather the scope of the invention also includes variations and modifications that would occur to persons skilled in the art upon reading the foregoing description and which are not in the prior art.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

I/We claim:

1. A user programmable cooking apparatus comprising:
at least one replaceable feeder; 2
at least one cookware; 1
at least one first sensor; 4
at least one second sensor; 5
a graphic user interface (GUI); 3
a monitoring station configured to communicate with the user to receive the cooking instructions and monitor the cooking apparatus; 6
a processor; wherein, 8
the processor receives a first set of information, recorded from the sensors, and the processor decomposes the set of information to generate a set of machine readable command sequences, which controls one or more replaceable feeders and the cookware;
wherein,
at least one first sensor is configured to capture the visual appearance of the ingredients during the cooking process; and
wherein,
at least one cookware, configured to cook the raw materials by one or more actions of boiling, mixing, filling, sautening and leavening;
wherein,
the apparatus is flexible enough to be installed in food trucks for transportation in different locations at different times.

2. A user programmable cooking apparatus of claim 1, wherein the said monitoring station continues to monitor the cooking process and sends information to the user, regarding the types of ingredients used, cooking phases, time duration of each cooking phase and images at key frames.

3. A user programmable cooking apparatus of claim 1, wherein the said monitoring station allows planning the dishes, controlling the amounts of the ingredients, timing of the dishes and suggesting variations and improvement of the dishes.

4. A user programmable cooking apparatus of claim 1, wherein the monitoring station is configured to receive information from the sensors.

5. A user programmable cooking apparatus of claim 1, wherein the at least first sensor is a camera that is configured to capture the appearance of the ingredients/dish during the cooking process.

6. A user programmable cooking apparatus of claim 1, wherein the second sensor comprises at least one of a temperature sensor for measuring temperature tin a location within the cookware, a weight-scale, volume sensor.

7. A user programmable cooking apparatus of claim 1, wherein the monitoring station is integrated with the cooking apparatus.

8. A user programmable cooking apparatus of claim 1, wherein the monitoring station is a separate apparatus.

9. A user programmable cooking apparatus of claim 1, wherein the GUI is utilized for controlling the inputting of ingredients.

10. A user programmable cooking apparatus of claim 1, wherein the apparatus works in a “regular mode” allowing the recipe to be prepared without monitoring and videotaping.

11. A user programmable cooking apparatus of claim 1, wherein the apparatus works in a “chef/debug mode”, wherein, the recipe is monitored, recorded and variations on the recipe performed automatically, and wherein, the variations undertaken by the apparatus can be viewed by the user.

12. A user programmable cooking apparatus of claim 1, wherein a set of pretested machine executable command sequences are previously stored in a database for executing the process of cooking.

13. A system of an automated cooking apparatus, using a user defined recipe comprising:
a network;
a cloud based server having a memory;
a database of recipes in communication with the network;
at least one replaceable feeder;
at least one cookware;
at least one first sensor;
at least one second sensor;
a graphic user interface (GUI);
a monitoring station configured to communicate with the user to receive the cooking instructions and monitor the cooking apparatus;
a processor; wherein,
the processor receives a first set of information, recorded from the sensors, and the processor decomposes the set of information to generate a set of machine readable command sequences, which controls one or more replaceable feeders and the cookware;
wherein,
at least one first sensor is configured to capture the visual appearance of the ingredients during the cooking process; and
wherein,
at least one cookware, configured to cook the raw materials by one or more actions of boiling, mixing, filling, sautening and leavening.

14. A system of an automated cooking apparatus of claim 9, wherein the cloud server manages, a database of recipes and tracks the inventory and manages supply.

15. A system of an automated cooking apparatus of claim 9, wherein the cloud server monitors actual orders, the pricing of the dishes dynamically, customer profiles and customer reaction to dishes.

16. A system of an automated cooking apparatus of claim 9, wherein the cloud server provides a visualization dashboard which functions as the monitoring station.

17. A system of an automated cooking apparatus of claim 12, wherein the visualization dashboard, visualizes the order flow and supply chain which leads to optimization by the cloud server to reduce the leftovers and returns, optimizing the dish cost, determining alternative ingredients.

18. A system of an automated cooking apparatus of claim 9, wherein the database of recipes comprises valuable information extracted from previously cooked recipes including:
nutritional value of different ingredients, allergens existing in each ingredient;
the change of nutritional value depending on the cooking techniques;
cost of each ingredient; and
the cost of energy units utilized during cooking (e.g., kWh, cost of cooking gas).

19. A system of an automated cooking apparatus of claim 9, wherein the database is utilized for calculating the cost of the dish and the nutritional value of the dish.

20. A system of an automated cooking apparatus of claim 9, wherein, the embodied software automatically determines the description of a typical dish and its name on the scale of popularity guided by deep learning, artificial neural network and applying predictive model.

21. A system of an automated cooking apparatus of claim 9, wherein an automated warning system regarding allergens and medical condition of the customers is provided.

22. A non transitory machine readable medium storing instructions that when executed causes a processor to implement a method for cooking the dish, the method comprising the steps of:
S1—sending instructions by the user via the GUI to the cooking apparatus for a recipe to be cooked;
S2—receiving cooking instructions by the cooking apparatus from the user, about the recipe to be cooked;
S3—executing the recipe by the cooking apparatus, aided by the monitoring station which receives various information from the sensors about the status of the recipe, including visual interpretation;
S4—displaying to the user real-time cooking status of the recipe through the GUI;
S5—prompting the user, to either modify the recipe or accept the recipe;
S6—updating the menu of the restaurant, upon the user accepting the recipe;
S7—repeating the steps from S1 upon the user modifying the recipe.

23. A non transitory machine readable medium storing instructions that when executed, as in claim 17, causing a processor to implement an analyzing component to the cooking method comprising the steps of:
sending instructions by the user via the GUI to the cooking apparatus for a recipe to be cooked;
receiving cooking instructions by the cooking apparatus from the user, about the recipe to be cooked, which sends information to the monitoring station, for analyzing the repository of recipes in the database, of the cloud server and selecting a plurality of variations of the recipe;
executing each of the variations of the recipe by the cooking apparatus and presenting them to the user for their selection;
selection of a preferred variation of the recipe by the user;
Updating the menu of the restaurant, with the selected variation of the recipe.
